(19) United States
(12) Patent Application Publication
(10) Pub. No.: US 2011/0061472 A1
(43) Pub. Date: Mar. 17, 2011

(54) BIOCHIP SYSTEM, METHOD FOR DETERMINING SPERM QUALITY AND METHOD FOR SEPARATING SPERM

(75) Inventors: Andrew M. Wo, Taipei (TW); Yu-An Chen, Taipei (TW); Fang-Sheng Tsai, Taoyuan County (TW); Zi-Wei Huang, Taipei (TW)

(73) Assignee: NATIONAL TAIWAN UNIVERSITY, Taipei (TW)

(21) Appl. No.: 12/763,217

(22) Filed: Apr. 20, 2010

Related U.S. Application Data
(60) Provisional application No. 61/276,529, filed on Sep. 14, 2009.

(51) Int. Cl. G01N 1/10

(52) U.S. Cl. 73/863.21

(57) ABSTRACT

A method for determining sperm quality is provided. At least one first microfluidic region and at least one second microfluidic region are provided, which meet at a junction. The second microfluidic region includes a shrunk portion with a width sized to substantially allow only one sperm to pass therethrough. A detector is disposed at the shrunk portion. First and second flow fields are formed in the first and second microfluidic regions, respectively. The first and second flow fields have different directions at the junction. A semen sample is loaded at a semen sample loading end. At least one sperm moves in the first microfluidic region against the direction of the first flow field and at least one sperm moves in the second microfluidic region along the direction of the second flow field. The detector generates a signal upon one sperm in the semen sample passing through the shrunk portion.

### CROSS-REFERENCE TO RELATED APPLICATION

This application claims the priority benefit of U.S. provisional application Ser. No. 61/276,529, filed on Sep. 14, 2009. The entirety of the above-mentioned patent application is hereby incorporated by reference herein and made a part of specification.

### BACKGROUND OF THE INVENTION

1. Field of the Invention

The present invention relates to a biochip system, and more particularly, to a lab-on-a-chip (LOC) for determining sperm quality or separating sperms.

2. Description of Related Art

In recent years, small-sized biochemical analysis systems have been vigorously developed and many microfluidics technologies have also been proposed for various applications. Because the small-sized analysis devices have the advantages of rapid analysis, low sample usage and space-saving, many analysis devices have been developed to be smaller and smaller, or even integrated into a single chip. Utilizing microfluidic chips to perform bio-medical inspection or analysis is also advantageous in reducing experimental errors arising from manual operation, increasing system stability, reducing power consumption and sample usage as well as saving labour force and time.

In general, the microfluidic chip is fabricated by using a semiconductor process to etch micro conduits in a glass or plastic substrate. An object to be inspected is allowed to flow in the micro conduits to sequentially perform the acts such as blend, separation and inspection. In other words, the entire function of the laboratory is integrated into the small sized cell to form a lab-on-a-chip (LOC).

### SUMMARY OF THE INVENTION

Accordingly, the present invention is directed to a biochip system capable of evaluating the sperm motility and separating and collecting sperms with different motility by establishing flow fields with opposite directions in microfluidic regions.

The present invention is also directed to a method for determining sperm quality and separating sperms, in which the semen sample does not need to undergo any preprocessing.

In one aspect, the present invention provides a method for determining spew quality. At least one first microfluidic region and at least one second microfluidic region are provided. The first microfluidic region and the second microfluidic region meet at a junction. The second microfluidic region includes a shrunk portion. The width of the shrunk portion is sized to substantially allow only one sperm to pass therethrough, and a detector is disposed at the shrunk portion. A first flow field is formed in the first microfluidic region and a second flow field is formed in the second microfluidic region. The first flow field and the second flow field have different directions at the junction. A semen sample is loaded at a semen sample loading end. At least one sperm moves in the first microfluidic region against the direction of the first flow field. At least one sperm moves in the second microfluidic region along the direction of the second flow field. The detector generates a signal upon one sperm in the semen sample passing through the shrunk portion.

In another aspect, the present invention provides a method for separating sperms. At least one first microfluidic region and at least one second microfluidic region are provided. The first microfluidic region and the second microfluidic region meet at a junction. An end of the second microfluidic region is provided with a collecting portion. A first flow field is foamed in the first microfluidic region and a second flow field is formed in the second microfluidic region. The first flow field and the second flow field have different directions at the junction. A semen sample is loaded at a semen sample loading end. At least one sperm moves in the first microfluidic region against the direction of the first flow field. At least one sperm moves in the second microfluidic region along the direction of the second flow field so as to be collected by the collecting portion. In addition, the velocity of the first flow field in the first microfluidic region may be varied to collect sperms with different motility.

In still another aspect, the present invention provides a biochip system including at least one first microfluidic region, at least one second microfluidic region, and a detector. The first microfluidic region and the second microfluidic region meet at a junction. The first microfluidic region has a first flow field therein, and at least one sperm moves in the first microfluidic region against the direction of the first flow field. The second microfluidic region comprises a shrunk portion. The width of the shrunk portion is sized to substantially allow only one sperm to pass therethrough. The second microfluidic region has a second flow field therein, and, at the junction, the direction of the first flow field in the first microfluidic region is different from the direction of the second flow field in the second microfluidic region. At least one sperm moves in the second microfluidic region along the direction of the second flow field. The detector is disposed at the shrunk portion and is adapted to generate a signal upon one sperm passing through the shrunk portion.

In view of the foregoing, the biochip system of the present invention employs a particular flow field design to enable sperms in the semen sample to overcome the background velocity to move upstream, thereby facilitating detecting the number and concentration of motile sperms or separating sperms with specific motility.

Besides, in the method for determining sperm quality and separating sperms, a simple design is employed to generate desired flow fields, and the semen sample does not need to undergo any preprocessing such as dyeing process, marking process, or centrifuging process. Therefore, the biochip system of the present invention is capable of rapidly determining the sperm quality and evaluating the sperm motility in a simplified manner, and further separating and collecting sperms with different motility.

In order to make the aforementioned and other features and advantages of the present invention more comprehensible, embodiments accompanied with figures are described in detail below.

### BRIEF DESCRIPTION OF THE DRAWINGS

FIG. 1A is a perspective view of a biochip system according to a first embodiment of the present invention.

FIG. 1B is a top, enlarged view of the area 110 of FIG. 1A.

FIG. 2A and FIG. 2B are schematic views showing a method for determining sperm quality carried out by the biochip system of the first embodiment.

FIG. 2B-1 is an enlarged view showing the path of the sperm passing through the shrunk portion of FIG. 2B.

FIG. 2C is a diagram showing the signal detected by the detector of one embodiment of the present invention.

FIG. 2C-1 is a partially enlarged view of the signal of FIG. 2C.

FIG. 3 is a top view of microfluidic regions of a biochip system according to a second embodiment of the present invention.

FIG. 4 illustrates a microfluidic region design according to a third embodiment of the present invention.

FIG. 5A and FIG. 5B illustrate the fourth embodiment of the biochip system that carries out the sperm quality determining method of the present invention.

FIG. 5C illustrates the signal detected by a detector according to one embodiment of the present invention.

FIG. 6A is a top view of microfluidic regions of a biochip system according to a fifth embodiment of the present invention.

FIG. 6B is a top view of microfluidic regions of a biochip system according to a sixth embodiment of the present invention.

FIG. 6C is a top view of microfluidic regions of a biochip system according to a seventh embodiment of the present invention.

FIG. 7A is a top view of a biochip system according to an eighth embodiment of the present invention.

FIG. 7B is a top, enlarged view of the junction 710 of FIG. 7A.

FIG. 7C is a top view of a biochip system according to a ninth embodiment of the present invention.

FIG. 8 is a comparison diagram of the percentage of motile sperm in a semen sample prior to and after a separation process using the biochip system 700 of FIG. 7A and FIG. 7B.

### DESCRIPTION OF THE EMBODIMENTS

The present invention provides a biochip system having microfluidic regions, which at least includes a substrate having an upper surface and microfluidic regions formed on the upper surface of the substrate. The biochip system employs microfluidics technology such that sperms can move upstream to a detecting region where a detector is disposed to cause the detector to generate an electrical signal. In this way, the detector detects the number of sperms that move upstream a fixed distance within a fixed time period, which reflects the number and concentration of motile sperms. In the biochip system described below, the microfluidic regions are implemented as micro conduits formed in a material layer over the substrate. It is noted that this is for the purposes of illustration only and should not be regarded as limiting. The microfluidic regions of the present invention could be fabricated in any manner as would be appreciated by those skilled in the art and therefore should not be limited to the particular embodiments described below.

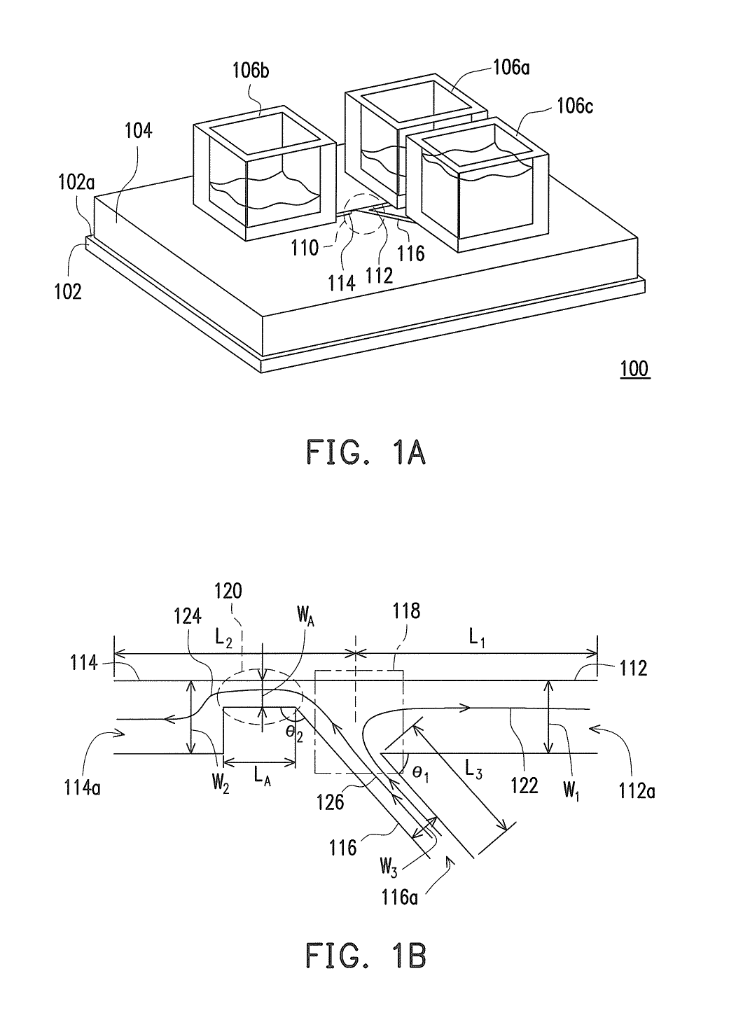

FIG. 1A is a perspective view of a biochip system according to a first embodiment of the present invention. FIG. 1B is a top, enlarged view of the area 110 of FIG. 1A.

Referring to FIG. 1A, the biochip system 100 includes a substrate 102 and a material layer 104 disposed over an upper surface 102a of the substrate 102. At least one microfluidic region 112, at least one microfluidic region 114, and at least one microfluidic region 116 are formed on the upper surface 102a of the substrate 102. Only one microfluidic region 112, one microfluidic region 114 and one microfluidic region 116 are illustrated in the drawings. It is noted that this is for the purposes of description only and the number and shape of the microfluidic regions described herein should not be regarded as limiting. The microfluidic regions 112, 114, 116 are, for example, formed in the material layer 104 and the substrate 102 serves as a bottom of the microfluidic regions 112, 114 and 116. The material of the substrate 102 is, for example, glass. The material of the material layer 104 may be a transparent bio-compatible material, for example, a soft transparent polymer material such as polydimethylsiloxane (PDMS). Because the soft and transparent PDMS material can easily be adhered onto the glass substrate and is resilient, a liquid can be directly injected into the material layer 104 without leakage. As such, with the microfluidic regions 112, 114 and 116 made of PDMS, the liquid in the material layer 104 is allowed to be observed and trapped at the same time.

In addition to the material layer 104, other components, such as reservoirs 106a, 106b and 106c, can be formed on the substrate 102. The reservoirs 106a, 106b and 106c are, for example, disposed on a surface of the material layer 104 in communication with the microfluidic regions 112, 114 and 116, respectively. The reservoirs 106a, 106b and 106c can be used to store or collect samples, reagents or buffer solutions.

In the area 110 shown in FIG. 1B, the microfluidic regions 112, 114 and 116 meet at a junction 118 such that they form microfluidic conduits that have a T-shaped configuration and communicate with one another. The microfluidic region 112 and the microfluidic region 114 extend, for example, in the same direction and are connected to the junction 118, while the microfluidic region 116 is connected to the junction 118, for example, at an angle with respect to the microfluidic regions 112 and 114.

The microfluidic region 112 has an end 112a positioned at a side opposite to the junction 118. The end 112a acts, for example, as a semen sample loading end and communicates with the reservoir 106a. The reservoir 106a contains, for example, a semen sample that does not undergo any preprocessing. The length L₁ of the microfluidic region 112 is about within the range from 0.05 mm to 40 mm, and the width W₁ of the microfluidic region 112 is about within the range from 5 um to 10000 um. The microfluidic region 114 has an end 114a positioned at a side opposite to the junction 118. The end 114a acts, for example, as an exit end for moving sperms and communicates with the reservoir 106b. The reservoir 106b contains, for example, RPMI 1640 nutrient solution. The length L₂ of the microfluidic region 114 is about within the range from 0.01 mm to 40 mm, and the width W₂ of the microfluidic region 114 is about within the range from 5 um to 10000 um. The microfluidic region 116 has an end 116a positioned at a side opposite to the junction 118. The end 116a acts, for example, as a flow field source end to provide a buffer solution and communicates with the reservoir 106c. The reservoir 106c contains, for example, the buffer solution that is prepared by mixing the RPMI 1640 nutrient solution and seminal plasma, wherein the seminal plasma may be used to prevent the sperm from adhering to the conduits. The length L₃ of the microfluidic region 116 is about within the range from 0.1 mm to 40 mm, and the width W₃ of the microfluidic region 116 is about within the range from 5 um to 10000 um. In addition, the conduit depth of the microfluidic regions 112, 114 and 116 in the material layer 104 is about within the range from 5 um to 100 um.

The microfluidic region 114 includes a shrunk portion 120 positioned, for example, adjacent the joining area between the microfluidic region 116 and the microfluidic region 114. In one embodiment, the shrunk portion 120 may be a channel extending in parallel with the extending direction of the microfluidic region 114 and the extending channel of the shrunk portion 120 has a length L_{A}. The shrunk portion 120, acting as a detecting region, has a smaller conduit width W_{A} such that only one sperm is allowed to pass therethrough at one time. That is, a part of the conduit wall of the microfluidic region 114 adjacent the junction 118 is recessed inwardly to narrow the conduit width at this part. Since the size of the sperm cell is about 2 um to 4 um, the conduit width W_{A} of the shrunk portion 120 can be designed to be about within 5 um to 20 um. A detector (not shown) is, for example, disposed at the shrunk portion 120 for detecting the single sperm passing through the shrunk portion 120 each time. The detector may be a counter designed under the Coulter principle to calculate the total number of sperms passing through the shrunk portion 120.

In one embodiment, at the junction 118, the microfluidic region 116 can be connected to the microfluidic regions 112 and 114 in a direction perpendicular or not perpendicular to the extending direction of the microfluidic regions 112 and 114. As shown in FIG. 1B, the conduit walls of the microfluidic region 116 and the microfluidic region 112 form, for example, an angle θ₁ at a joining area therebetween. The conduit walls of the microfluidic region 116 and the microfluidic region 114 around the shrunk portion 120 form, for example, an angle θ₂ at a joining area therebetween. The angle θ₁ and the angle θ₂ may be arbitrary values and may be equal or different. It is not intended to limit the angles to any particular value in the present invention.

It is noted that the microfluidic regions 112, 114 and 116 can have stable flow fields 122, 124 and 126, respectively, by controlling the velocity of the fluid in the biochip system 100 of the first embodiment. Specifically, the buffer solution is injected via the end 116a into the microfluidic region 116 as a flow field source to provide a flow field 126 with high flow velocity in the microfluidic region 116. When flowing from the end 116a to the junction 118, the buffer solution is separated into two parts, one of which flows from the junction 118 to the end 112a to form a flow field 122, and the other of which flows from the junction 118, through the shrunk portion 120 and to the end 114a to form a flow field 124. That is, the direction of the flow field 122 is opposite to the direction of the flow field 124.

The velocity of the flow field 122 in the microfluidic region 112 is considered as a background flow velocity, which is, for example, a threshold for determining or screening motility of sperm in a semen sample. In one embodiment, when the semen sample is loaded at the end 112a of the microfluidic region 112, sperms in the semen sample move in a direction against the flow field 122 in the microfluidic region 112. When the moving sperms can overcome the velocity of the flow field 122, the sperms can move upstream in the microfluidic region 112 toward the junction 118. After passing through the junction 118, the sperms are carried by the flow field 124 in the microfluidic region 114 toward a second end and to pass through the detecting region at the shrunk portion 120 in the direction of the flow field 124. On the contrary, when the moving sperms cannot overcome the velocity of the flow field 122, the sperms are flushed downstream with the buffer solution in the microfluidic region 112. In other words, those sperms with a certain level of motility can be detected or screened out by setting a proper velocity of the flow field 122 such that the motile sperms can overcome the flow field 122 to move upstream toward the junction 118 and can be detected or screened out by the detector disposed at the shrunk portion 120. In general, the moving speed of sperms is about within the range from 1 um/s to 70 um/s. The maximum velocity of the flow field 122 is substantially less than the maximum moving speed of the sperms. For example, the velocity of the flow field 122 can be set to be within the range from 5 um/s to 80 um/s.

In addition, the velocity of the flow field 126 in the microfluidic region 116 is substantially greater than the moving speed of the sperms to prevent the sperms passing through the junction 118 from entering the microfluidic region 116. The maximum velocity of the flow field 126 is, for example, about within the range from 80 um/s to 150 um/s. The buffer solution flowing from the microfluidic region 116 into the microfluidic region 114 can generate a flow field 124 with high velocity at the time of passing through the shrunk portion 120. The velocity of the flow field 124 is, for example, greater than the velocity of the flow field 122 and greater than the moving speed of the sperms, such that the sperms moving upstream to the junction 118 can be carried to pass through the shrunk portion 120 rapidly. The maximum velocity of the flow field 124 is, for example, about within the range from 80 um/s to 150 um/s. In one embodiment, the maximum velocity of the flow field 124 is 100 um/s.

The velocity of the flow field 122, 124 and 126 can be adjusted by changing the height of liquid in the reservoirs 106a, 106b and 106c to generate different hydrostatic pressure or by modifying the width of the microfluidic regions 112, 114 and 116. In one embodiment, the height of liquid in the reservoir 106c is greater than the height of liquid in the reservoir 106b and, therefore, the buffer solution in the reservoir 106c can flow from the microfluidic region 116 into the microfluidic regions 112 and 114, thereby establishing the flow field with the desired direction.

The method for determining sperm quality will now be described below in conjunction with the biochip system 100 illustrated in FIG. 1A and FIG. 1B. However, embodiments described below are for the purposes of illustration only and should not be regarded as limiting.

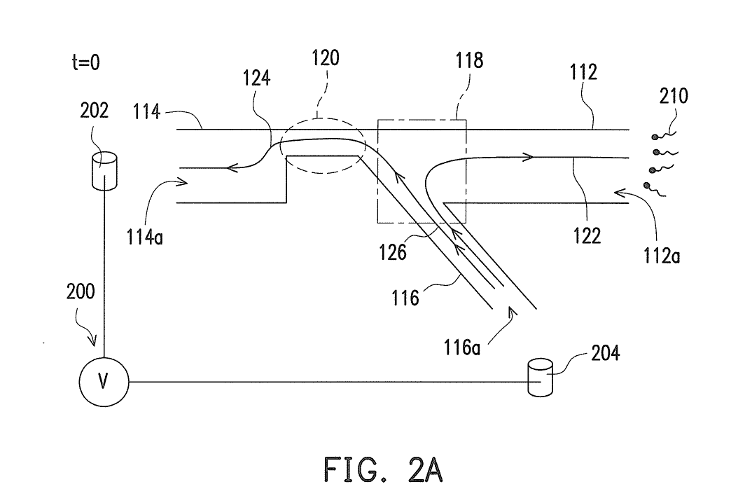

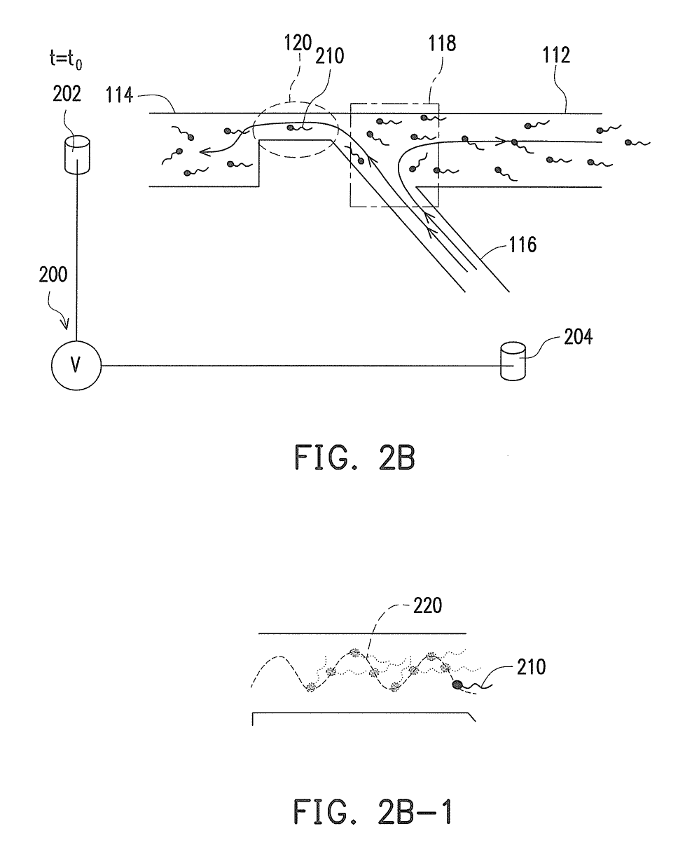

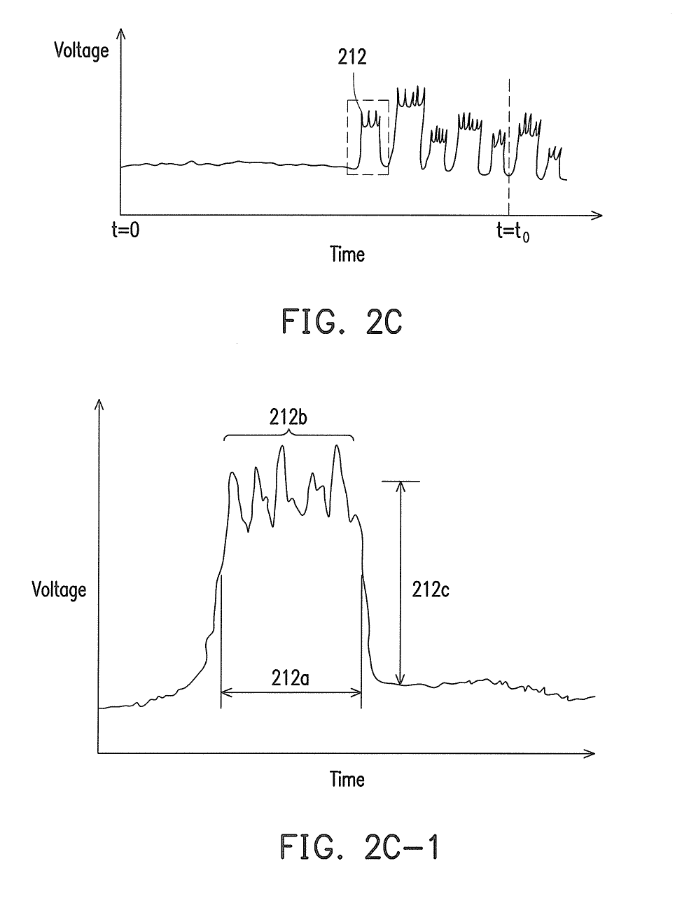

FIG. 2A and FIG. 2B are schematic views showing a method for determining sperm quality carried out by the biochip system of the first embodiment. FIG. 2C is a diagram showing the signal detected by the detector of one embodiment of the present invention. FIG. 2B-1 is an enlarged view showing the path of the sperm passing through the shrunk portion of FIG. 2B. FIG. 2C-1 is a partially enlarged view of the signal of FIG. 2C.

The detector 200 used in FIG. 2A and FIG. 2B is, for example, a counter designed under the Coulter principle, which includes an electrode 202 and an electrode 204 disposed in the microfluidic region 114 and the microfluidic region 116, respectively. The detector 200 provides a constant current to measure an impedance variation caused by sperms 210 passing through the shrunk portion 120 within a fixed time period. The measuring results are shown in FIG. 2C.

Referring to FIG. 2A and FIG. 2C, at an initial state (t=0), an initial sample containing sperms 210 is loaded at the end 112a of the microfluidic region 112. At least one of the sperms 210 is able to overcome the flow field 122 of the microfluidic region 112 to move upstream toward the junction 118. Once passing through the microfluidic region 112 and reaching the junction 118 after a period of time, the sperm 210 is carried by the flow field 124 toward the end 114a and to pass through the shrunk portion 120, causing the detector 200 to generate an electrical signal. It is noted that, due to the narrow width of the conduit at the shrunk portion 120, when the sperm 210 passes through the micro shrunk portion 120, it causes an increase of resistance. Under the condition that the two sides of the shrunk portion 120 are provided with a constant current, the detector 200 can generate a voltage pulse 121 as a detecting signal while the sperm 210 passes through the shrunk portion 120.

After measuring for a specific time period (t=t0), as shown in FIG. 2B and FIG. 2C, each sperm 210 passing through the shrunk portion 120 causes a pulse in the signal detected by the detector. As such, the sperm number and concentration can be calculated by detecting the electrical signal within the specific time period. In other words, each time only one sperm 210 is able to pass through the extending channel of the shrunk portion 120 and, therefore, the voltage signal detected by the detector can have only one pulse 212 during the relatively short time period when the sperm 210 is being passing through the shrunk portion 120. The continuous multiple pulses 212 as shown in FIG. 2C indicate that multiple sperms 210 pass through the extending channel of the shrunk portion 120 one by one. Therefore, each sperm 210 passing through the shrunk portion 120 causes a corresponding pulse signal 212 detected by the detector over time.

As shown in FIG. 2B-1 and FIG. 2C-1, it is noted that, because the shrunk portion 120 has the extending channel with length L_{A}, the electrical signal detected when a single sperm 210 passes through the shrunk portion 120 can provide information relating to the sperm speed, size and vibration according to a movement path along which the same sperm moves in the shrunk portion 120 or a manner in which the sperm vibrates. In other words, when a single sperm passes through the shrunk portion 120, different sperms have different motility and flagellum vibration manners and therefore have different movement paths. As such, when one single sperm passes through the shrunk portion 120, the pulse signal detected is different, thereby providing characteristics of the corresponding sperm passing through the shrunk portion 120.

For example, as shown in FIG. 2C-1, each voltage pulse 212 generated by the detector 200 at the time the sperm 210 passes through the shrunk portion 120 is a pulse signal that maintains a high voltage for a period of time rather than having only one peak. The duration 212a of the pulse 212 depends on, for example, the moving speed of the sperm 210 passing through the shrunk portion 120. In addition, each voltage pulse 212 has multiple fluctuations 212b on its wave crest. The fluctuations 212b of the pulse 212 depend on, for example, the manner in which the sperm 210 vibrates in the shrunk portion 120. The amplitude of the pulse 212 depends on, for example, the size of the sperm 210 passing through the shrunk portion 120.

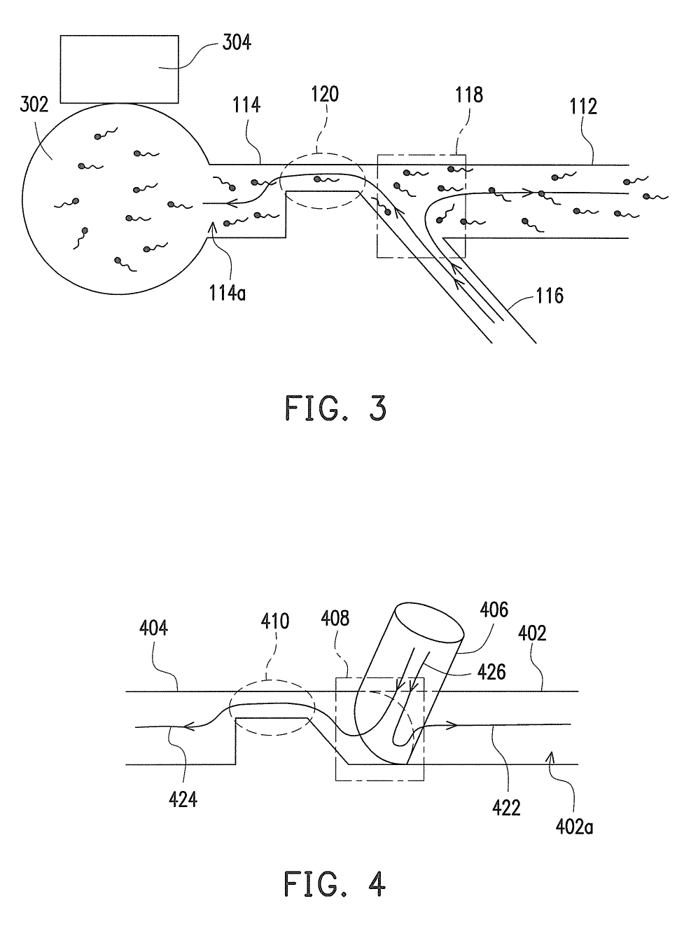

FIG. 3 is a top view of microfluidic regions of a biochip system according to a second embodiment of the present invention.

In another embodiment, the biochip system can further include a collecting portion 302 in communication with the microfluidic region 114. The collecting portion 302 is, for example, connected to the end 114a of the microfluidic region 114, for collecting the sperms that have a sperm motility sufficient to overcome the flow field 122 in the microfluidic region 112 to pass through the junction 118 and shrunk portion 120 and are carried to the end 114a. The collecting portion 302 may also be the reservoir 106b of FIG. 1A for storing the sperms that move upstream through the junction 118 and are carried to the end 114a by the flow field 124. Therefore, in addition to being able to detect the sperm number and sperm concentration in the manner illustrated in FIG. 2A and FIG. 2B, the biochip system of the present embodiment can also separate the motile sperms from the initial sample. Besides, the biochip system can further be provided with an observation device 304 at the end 114a, for example, a microscope and a charge coupled device (CCD) for observing the morphology of the collected sperms. Because the collected sperms are able to overcome the background flow field 122 in the microfluidic region 112 to move upstream, the sperm motility can also be evaluated by setting the velocity of the background flow field 122.

While the biochip system is illustrated as forming three microfluidic regions with different flow velocity on the upper surface of the substrate in the above embodiments, it is noted that this is for the purposes of illustration only and should not be regarded as limiting. Rather, in other embodiments, the microfluidic region can be configured differently, as described below.

FIG. 4 illustrates a microfluidic region design according to a third embodiment of the present invention.

As shown in FIG. 4, in one embodiment, two microfluidic regions 402 and 404 in communication with each other are formed on the upper surface of the substrate. For example, the microfluidic region 402 and the microfluidic region 404 extend in the same direction and are connected to a junction 408. Another microfluidic region 406 is connected to the junction 408 and the microfluidic region 406 is not located on the plane on which the microfluidic regions 402 and 404 are located. The microfluidic region 406 is, for example, a component that can provide a high velocity flow field. The microfluidic region 406 may be an injector that injects the buffer solution into the microfluidic regions 402 and 404 from above the microfluidic regions 402 and 404.

Similarly, when the externally injected buffer solution flows from the microfluidic region 406 to the junction 408, it forms a high velocity flow field 426 and is separated into two parts at the junction 408. One part of the buffer solution flows from the junction 408 toward the microfluidic region 402 to form a flow field 422, and the other part of the buffer solution flows from the junction 408, through the shrunk portion 410, toward the microfluidic region 404 to form a flow field 424, thus resulting in the two flow fields 422 and 424 with opposite directions. As such, when a sperm loaded at the end 402a of the microfluidic region 402 is able to overcome the flow field 422 of the microfluidic region 402 to move upstream toward the junction 408, the sperm can be carried by the flow field 424 toward the microfluidic region 404 and to pass through the detecting region at the shrunk portion 410, causing the detector to generate an electrical signal.

The shrunk portion is described as having an extending channel with a length L_{A} in the above embodiments. However, this is for the purposes of illustration only and should not be regarded as limiting. It would be understood by those skilled in the art that the shrunk portion may also be a structure without an extending channel as long as the conduit width at the shrunk portion is sized to allow only one sperm to pass therethrough at one time so that the shrunk portion can be used as a detecting region. Another structure of the shrunk portion is described below with reference to a fourth embodiment of the biochip system. It should be understood that the shrunk portion of the biochip system of the fourth embodiment can also be applied in any one of the other embodiments and therefore should not be limited to this particular application as illustrated in the drawings.

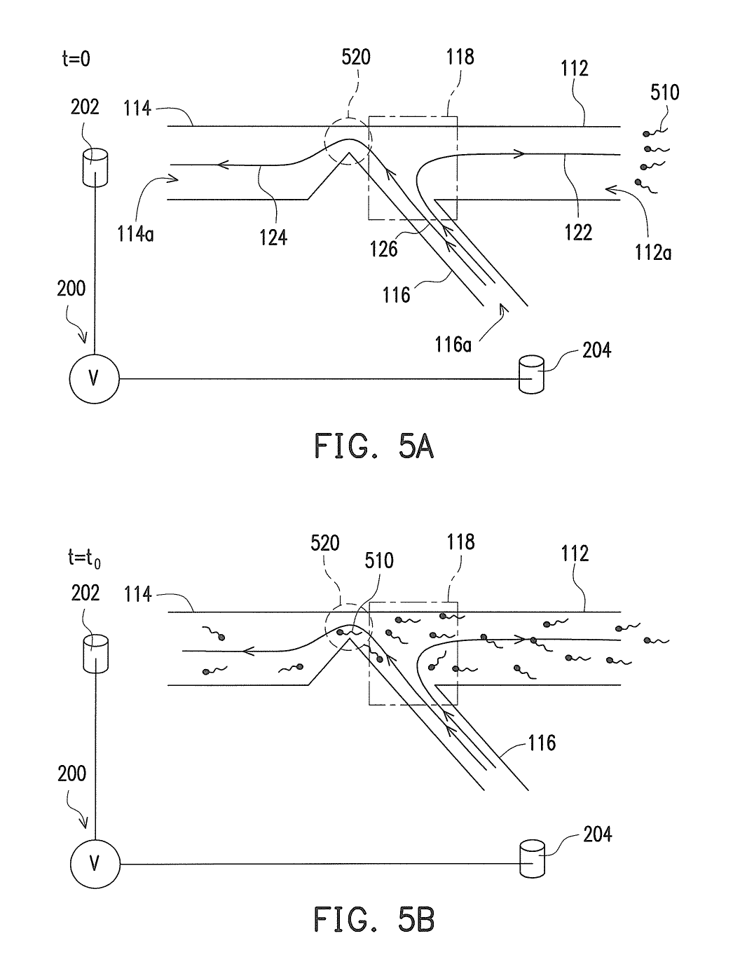

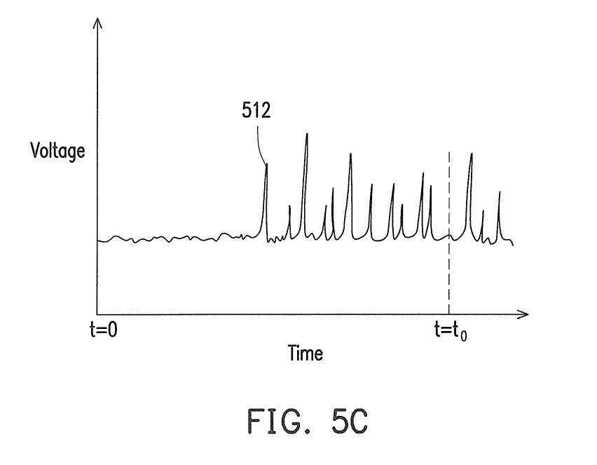

FIG. 5A and FIG. 5B illustrate the fourth embodiment of the biochip system that carries out the sperm quality determining method of the present invention. FIG. 5C illustrates the signal detected by a detector according to one embodiment of the present invention. It is noted that, in FIG. 5A and FIG. 5B, elements that are the same as in FIG. 2A and FIG. 2B are referenced by the same numerals and explanation thereof is not repeated herein.

In the fourth embodiment, the main elements of the biochip system of FIG. 5A and FIG. 5B are substantially the same as that in FIG. 2A and FIG. 2B. The main difference lies in the configuration of the shrunk portion 520. As shown in FIG. 5A, the shrunk portion 520 is an extending channel without a specific length. In other words, the shrunk portion 520 is, for example, a structure with an aperture, which likewise allows only one single sperm to pass therethrough at one time. The conduit wall at the interconnecting area between the microfluidic region 114 and the microfluidic region 116 is recessed inwardly at a position adjacent the junction 118 to form a cusp, thus resulting in a narrow conduit width at the shrunk portion 520.

Similarly, the detector 200 used in FIG. 5A and FIG. 5B is, for example, a counter designed under the Coulter principle, which includes an electrode 202 and an electrode 204 disposed in the microfluidic region 114 and the microfluidic region 116, respectively. The detector 200 provides a constant current to measure an impedance variation caused by sperms 510 passing through the shrunk portion 520 within a fixed time period. The measuring results are shown in FIG. 5C.

Referring to FIG. 5A and FIG. 5C, at an initial state (t=0), an initial sample containing sperms 510 is loaded at the end 112a of the microfluidic region 112. At least one of the sperms 510 is able to overcome the flow field 122 of the microfluidic region 112 to move upstream toward the junction 118. The sperm 210 is then carried by the flow field 124 toward the end 114a and to pass through the shrunk portion 520. At the moment when the sperm 510 passes through the shrunk portion 520, the sperm 510 causes an increase of resistance. Therefore, the detector 200 generates a voltage pulse 512 as a detecting signal while the sperm 510 passes through the shrunk portion 520.

After measuring for a specific time period (t=t0), as shown in FIG. 2B and FIG. 2C, each sperm 510 passing through the shrunk portion 520 causes a pulse 512 in the signal detected by the detector. As such, the sperm number and concentration can be calculated by detecting the electrical signal within the specific time period.

It is to be understood that the present invention can be implemented in other embodiments other than the embodiments described above. In the above embodiments, the two flow fields at the junction have opposite directions, and the microfluidic region connected to the semen sample loading end and the microfluidic region connected to the motile sperm exit end are arranged and connected along a same straight line. However, this is for the purposes of illustration only and should not be regarded as limiting. In other embodiments, the microfluidic region connected to the semen sample loading end and the microfluidic region connected to the motile sperm exit end can be arranged and connected in any suitable fashion, as long as at least two flow fields with opposite directions are formed at the junction, which are described below by way of examples.

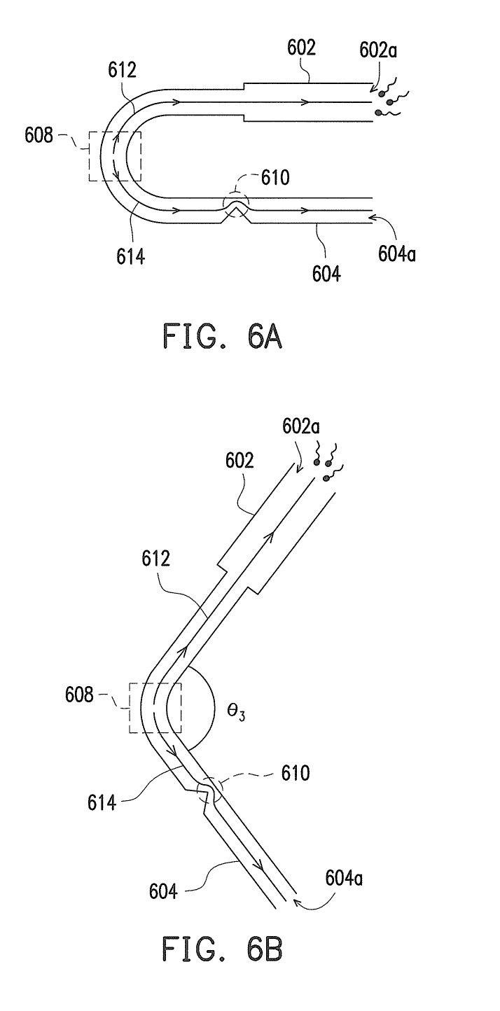

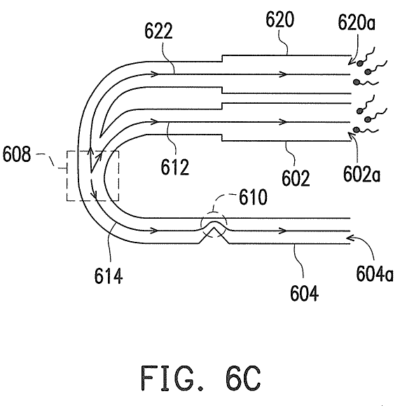

FIG. 6A is a top view of microfluidic regions of a biochip system according to a fifth embodiment of the present invention. FIG. 6B is a top view of microfluidic regions of a biochip system according to a sixth embodiment of the present invention. FIG. 6C is a top view of microfluidic regions of a biochip system according to a seventh embodiment of the present invention. For clarity, FIG. 6A, FIG. 6B and FIG. 6C mainly show the configurations of the microfluidic region connected to the semen sample loading end and the microfluidic region connected to the motile sperm exit end, without showing the microfluidic region that acts as the flow field source. Besides, like elements are referenced by like numerals and explanation thereof is therefore not repeated herein.

Referring to FIG. 6A, in the fifth embodiment, a microfluidic region 602 is connected to a microfluidic region 604 at a junction 608. The microfluidic region 602 has an end 602a at a side opposite to the junction 608. The end 602 is, for example, used as a semen sample loading end. The microfluidic region 604 has an end 604a at a side opposite to the junction 608. The end 604a is, for example, used as an exit end for motile sperms. The microfluidic region 604 includes a shrunk portion 610 which is, for example, positioned adjacent the junction. Besides, the biochip system of the fifth embodiment further includes another microfluidic region (not shown) connected to the junction 608, acting as a flow field source.

The microfluidic region 602 and the microfluidic region 604 are interconnected to form a U-like configuration. The microfluidic region 602 and the microfluidic region 604 are, for example, arranged in parallel except for the areas adjacent the junction 608. Namely, the part of microfluidic region 602 adjacent the end 602a and the part of microfluidic region 604 adjacent the end 604a extend in the same direction. By controlling the flow velocity, stable flow fields 612 and 614 are formed in the microfluidic regions 602 and 604, respectively. The buffer solution injected from the flow field source end flows from the junction 608 to the microfluidic region 602 and the microfluidic region 604, respectively, and, therefore, the flow field 612 and the flow field 614 have different directions at the junction 608. As such, motile sperms in the semen sample are able to move against the flow field 612 to pass through the junction 608, and are then carried by the flow field 614 in the microfluidic region 604 toward the end 604 and to pass through the detecting region at the shrunk portion 610.

Referring to FIG. 6B, the main elements of the biochip system of the sixth embodiment are similar to that of the fifth embodiment. The main difference lies in the angle θ3 between the microfluidic region 602 and the microfluidic region 604. The microfluidic region 602 and the microfluidic region 604 may also be arranged in a nonparallel fashion thus forming an angle θ3 at the junction 608. The angle θ3 may be of any suitable values.

In addition, the present invention is not intended to limit the number of the microfluidic regions to any particular number described herein. Referring to FIG. 6C, the main elements of the biochip system of the seventh embodiment of the present invention are similar to that of the fifth embodiment. The main difference lies in the number of the microfluidic regions connected to the semen sample loading end. In the seventh embodiment, the microfluidic regions 602, 604 and 620 are connected at the junction 608. The microfluidic region 620 has an end 620 acting as a semen sample loading end. The buffer solution injected from the flow field source end flows from the junction 608 to the microfluidic regions 602, 620 and 604, respectively. Therefore, a stable flow field 622 is also formed in the microfluidic region 620, and the flow fields 612, 622 and 614 have different directions at the junction 608. In other words, motile sperms in the semen sample are able to move against the flow field 612 in the microfluidic region 602 or move against the flow field 622 in the microfluidic region 620 toward the junction 608. In one embodiment, the end 602a and end 620a both used as the semen sample loading end may or may not be connected to each other.

While the biochip system is illustrated as having two microfluidic regions connected to the semen sample loading end in FIG. 6C, it is to be understood that the biochip system can have multiple microfluidic regions connected to the motile sperm exit end or multiple microfluidic regions connected to the flow field source end in other embodiments. As would be appreciated by those skilled in the art upon reading the foregoing description, various elements of the biochip system can be modified or used in combination without departing from the spirit and scope of the present invention, which are therefore not described herein further.

The present invention further provides a biochip system with microfluidic regions, which at least includes a substrate with an upper surface and a plurality of microfluidic regions formed on the upper surface of the substrate. This biochip system employs the microfluidics technology to design the flow field such that sperms can move upstream a fixed distance before being carried to a collecting end and the sperms with different motility can be screened out or separated by controlling the velocity of a background flow field.

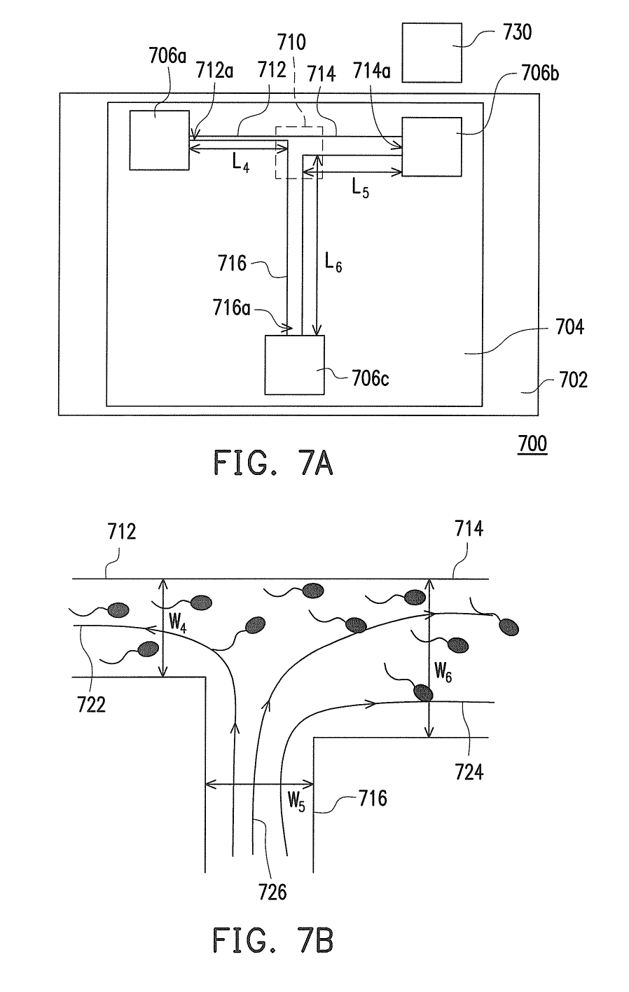

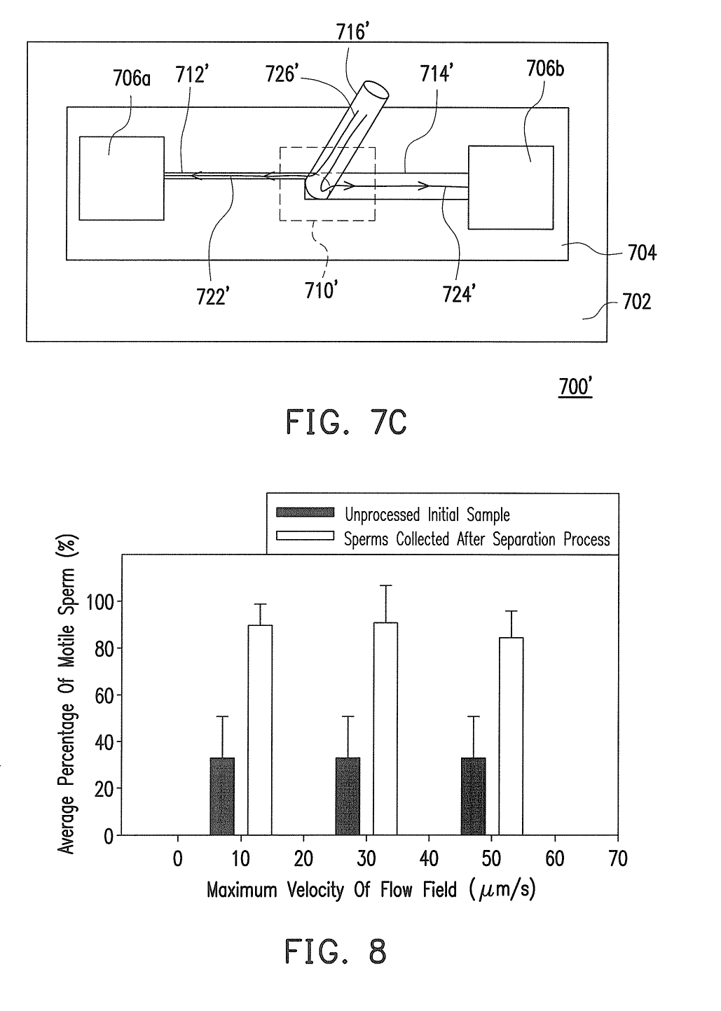

FIG. 7A is a top view of a biochip system according to an eighth embodiment of the present invention. FIG. 7B is a top, enlarged view of the junction 710 of FIG. 7A.

Referring to FIG. 7A, the biochip system 700 at least includes a substrate and a material layer 704 disposed over an upper surface of the substrate 702. Microfluidic regions 712, 714 and 716 are formed on the upper surface of the substrate 702. The microfluidic regions 712, 714 and 716 are, for example, fowled in the material layer 704 and the substrate 702 serves as a bottom of the microfluidic regions 712, 714 and 716. The material of the substrate 702 is, for example, glass. The material of the material layer 704 may be a transparent bio-compatible material, for example, a soft transparent polymer material such as polydimethylsiloxane (PDMS). In one embodiment, the biochip system 700 may further include reservoirs 706a, 706b and 706c for storing samples, reagents or buffer solutions. The reservoirs 706a, 706b and 706c are, for example, disposed on a surface of the material layer 704 and communicate with the microfluidic regions 712, 714 and 716, respectively.

Referring to FIG. 7A and FIG. 7B, the microfluidic regions 712, 714 and 716 are fluidly connected with one another to form a T-shaped microfluidic conduit. The microfluidic region 712 and the microfluidic region 714 extend, for example, in the same direction and are connected to each other, while the microfluidic region 716 is connected to the junction 710, for example, at an angle perpendicular to the microfluidic regions 112 and 114.

The microfluidic region 712 has an end 712a acting, for example, as a semen sample loading end and communicating with the reservoir 706a. The reservoir 706a contains, for example, a semen sample that does not undergo any preprocessing. The length L₄ of the microfluidic region 712 is about within the range from 0.05 mm to 40 mm, and the width W₄ of the microfluidic region 712 is about within the range from 5 um to 10000 um. The microfluidic region 714 has an end 714a acting, for example, as an exit end for moving sperms and communicating with the reservoir 706b. The reservoir 706b contains, for example, RPMI 1640 nutrient solution. The length L₅ of the microfluidic region 714 is about within the range from 0.01 mm to 40 mm, and the width W₅ of the microfluidic region 714 is about within the range from 10 um to 10000 um. The microfluidic region 716 has an end 716a acting, for example, as a flow field source end to provide a buffer solution and communicating with the reservoir 706c. The reservoir 706c contains, for example, the buffer solution that is prepared by mixing the RPMI 1640 nutrient solution and seminal plasma, where the seminal plasma may be used to prevent the sperm from adhering to the conduits. The length L₆ of the microfluidic region 716 is about within the range from 0.01 mm to 40 mm, and the width W6 of the microfluidic region 716 is about within the range from 5 um to 10000 um. In addition, the conduit depth of the microfluidic regions 712, 714 and 716 in the material layer 704 is about within the range from 5 um to 1000 um.

As shown in FIG. 7B, in the biochip system 700, the buffer solution injected via the end 716a provides a flow field 726 with high flow velocity in the microfluidic region 716. When flowing from the end 716a to the junction 718 of the microfluidic regions 712, 714 and 716, one part of the buffer solution flows to the end 712a to form a flow field 722, and the other part of the buffer solution flows to the end 714a to form a flow field 724. The direction of the flow field 722 is opposite to the direction of the flow field 724. In one embodiment, when the semen sample is loaded at the end 712a of the microfluidic region 712, sperms in the semen sample must overcome the background flow velocity of the flow field 722 before moving upstream toward the junction 710. Once passing through the junction 710, the sperms can pass through the microfluidic region 714 and reach the collecting end rapidly with the aid of the high velocity flow field 724.

The maximum velocity of the flow field 722 is substantially less than the maximum moving speed of the sperms, and, for example, can be set to be about within the range from 5 um/s to 80 um/s. The maximum velocity of the flow field 724 is greater than the moving speed of the sperms, and, for example, is about within the range from 80 um/s to 150 um/s. In one embodiment, the maximum velocity of the flow field 724 is 100 um/s. The maximum velocity of the flow field 726 is, for example, about within the range from 80 um/s to 150 um/s.

In one embodiment, sperms with different motility can be separated by setting different velocity of the flow field 722. For example, when the maximum velocity of the flow field 722 is set to be 10 um/s, a large number of motile sperms can be collected; when the maximum velocity of the flow field 722 is set to be 30 um/s, a lesser number of motile sperms can be collected as compared with the case of the flow field velocity of 10 um/s; when the maximum velocity of the flow field 722 is set to be 50 um/s, a further lesser number of motile sperms can be collected while the sperm motility of the collected sperms in this case is stronger. In other words, the number of the sperms collected at the end 714a that have sufficient motility to overcome the background velocity decreases with the increase of the velocity of the flow field 722. In addition, in one embodiment, an observation device 730, for example, a microscope and a charge coupled device (CCD), can further be provided at the end 714a to observe the morphology of the collected sperms. Because the collected sperms are able to move against the background flow field 722 toward the junction 710, the sperm motility of the separated sperms can be evaluated based on the set velocity of the flow field 722.

The velocity of the flow field 722, 724 and 726 can be adjusted by changing the height of liquid in the reservoirs 706a, 706b and 706c to generate different hydrostatic pressure or by modifying the width of the microfluidic regions 712, 714 and 716. In one embodiment, the height of liquid in the reservoir 706c is greater than the height of liquid in the reservoirs 706a and 706b, and, therefore, the buffer solution in the reservoir 706c can establish the flow fields 722, 724 with opposite directions in the microfluidic regions 712, 714, respectively.

While the microfluidic region 716 is illustrated as being connected to the microfluidic regions 712 and 714 at a right angle in the embodiment of FIGS. 7A and 7B, it is to be understood that this is for the purposes of illustration only and therefore should not be regarded as limiting. Rather, in other embodiments, the microfluidic region 716 may also be connected to the junction 710 at an angle not perpendicular to the extending direction of the microfluidic regions 712 and 714.

In addition, in another embodiment, the microfluidic region 714 of FIG. 7A and FIG. 7B may also be configured to include a shrunk portion 120 of FIG. 1B and a detector disposed at the shrunk portion as a detecting region (not shown). The shrunk portion of the microfluidic region 714 is, for example, parallel to the extending direction of the microfluidic region 714 and includes an extending channel having a specific length. Besides, the shrunk portion of the microfluidic region 714 may be disposed adjacent a connecting area of the microfluidic region 716 and the microfluidic region 714, or disposed between the junction 710 and the end 714a. Therefore, the present invention is not intended to limit the shrunk portion to any particular position described herein. As such, in addition to separating and collecting sperms with different motility by varying the background velocity of the flow field 722, the present biochip system can also determine the sperm quality of the sperms that are screen out by passing through the shrunk portion with the detector disposed at the microfluidic region 714. Determining the sperm quality of each sperm passing through the shrunk portion of the microfluidic region 714 using the detector may be performed in the manner similar to that illustrated in FIG. 2A and FIG. 2C and therefore is not repeated herein.

While three microfluidic regions with different flow fields are foamed on the upper surface of the substrate in the embodiment of FIG. 7A and FIG. 7B, it is noted that the microfluidic region 716 may be replaced with another element that can provide a high velocity flow field, which is described below with reference to FIG. 7C. FIG. 7C is a top view of a biochip system according to a ninth embodiment of the present invention, wherein elements that are the same as in FIG. 7A and FIG. 7B are referenced by the same numerals and explanation thereof is not repeated herein.

Referring to FIG. 7C, only two microfluidic regions 712′ and 714′ in communication with each other are formed on the upper surface of a substrate 702 of a biochip system 700′. The microfluidic region 712′ and the microfluidic region 714′ extend in the same direction and meet at a junction 710′. In addition, the microfluidic region 716′ connected to the junction 710′ is disposed above the substrate 702 and is not located on the plane on which the microfluidic regions 712′ and 714′ are located. The microfluidic region 716′ is, for example, an element capable of providing a high velocity flow field, such as, an injector that injects the buffer solution into the microfluidic regions 712′ and 714′ from above the junction 710′.

When the buffer solution is injected from the microfluidic region 716′ to the junction 710′, it forms a flow field 722′ in the microfluidic region 712′ and a flow field 724′ in the microfluidic region 714′. Because the direction of the flow field 722′ is opposite to the direction of the flow field 724′, the biochip system 700′ can also provide flow fields similar to that shown in FIG. 7B. When a semen sample is loaded at the end of the microfluidic region 712′, if a sperm is able to overcome the velocity of the flow field 722′ to move upstream toward the junction 710′, the sperm can be rapidly carried to the collecting end by the high velocity flow field 724′ after passing through the junction 710′.

In order to verify the biochip system is indeed capable of effectively separating sperms with specific motility, several experiments are conducted which will now be described below. It is to be understood that this is for the purposes of illustrating the sperm separating results under different flow field configurations of the biochip system and should not be regarded as limiting.

### Experiments

FIG. 8 is a comparison diagram of the percentage of motile sperm in a semen sample prior to and after a separation process using the biochip system 700 of FIG. 7A and FIG. 7B.

As shown in FIG. 8, the experiments use four different semen samples. These semen samples are loaded at the ends 712a of the microfluidic regions 712 with the maximum flow field velocity of 10 um/s, 30 um/s, and 50 um/s, respectively, and sperms capable of overcoming different background flow field velocity to move upstream are collected. The sperm collecting ends 20 minutes later. The percentage of motile sperms in the semen collected at respective collecting ends with different flow field velocity, together with the percentage of sperms in the initial semen sample without undergoing any separation processing, are then plotted in the comparison diagram of FIG. 8. From the comparison it can be apparent that the percentage of motile sperm in the semen samples undergoing the separation process at three maximum velocities using the biochip system of the present invention is much greater than the percentage of motile sperm in the initial unprocessed semen sample. Furthermore, the percentage of motile sperm after the semen undergoes the separation process is close to 100%, which means the separated sperms almost all have a certain level of motility.

In summary, the biochip system of the present invention employs the microfluidics technology to design the flow field such that sperms in the semen sample can overcome the background velocity to move upstream and the sperm number and concentration of sperms that move upstream a fixed distance within a fixed time period can be detected, thus facilitating evaluating the sperm motility. In addition, the biochip system of the present invention is capable of screening out or separating the sperms with different specific motility by controlling the velocity of the background flow field.

Besides, in the method for determining sperm quality and separating sperms, a simple structure is used to generate desired flow fields in the microfluidic regions to determine the sperm concentration of the sperms capable of moving upstream to further evaluate the sperm motility and collect sperms with a certain level of motility. Moreover, the semen sample does not need to undergo any preprocessing such as dyeing process, marking process, or centrifuging process. Therefore, the biochip system of the present invention is capable of rapidly determining the sperm quality and evaluating the sperm motility in a simplified manner, and further separating and collecting sperms with different motility by controlling the background flow field velocity.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for determining sperm quality, comprising:
providing at least one first microfluidic region and at least one second microfluidic region, the first microfluidic region and the second microfluidic region meeting at a junction, the second microfluidic region comprising a shrunk portion, the width of the shrunk portion being sized to substantially allow only one sperm to pass therethrough, a detector being disposed at the shrunk portion;
forming a first flow field in the first microfluidic region and forming a second flow field in the second microfluidic region, the first flow field and the second flow field having different directions at the junction; and
loading a semen sample at a semen sample loading end, at least one sperm moving in the first microfluidic region against the direction of the first flow field, at least one sperm moving in the second microfluidic region along the direction of the second flow field,
wherein the detector generates a signal upon one sperm in the semen sample passing through the shrunk portion.

2. The method for determining sperm quality according to claim 1, further comprising providing at least a third microfluidic region, wherein fluid in the third microfluidic region flows into the first microfluidic region and the second microfluidic region.

3. The method for determining sperm quality according to claim 2, wherein the maximum flow field velocity provided by the third microfluidic region is greater than the moving speed of sperm.

4. The method for determining sperm quality according to claim 2, wherein there is no sperm in the third microfluidic region substantially.

5. The method for determining sperm quality according to claim 1, wherein the shrunk portion is an aperture or an extending channel having a length.

6. The method for determining sperm quality according to claim 1, wherein the maximum velocity of the first flow field in the first microfluidic region is substantially less than the moving speed of sperm.

7. The method for determining sperm quality according to claim 1, wherein the maximum velocity of the second flow field in the second microfluidic region is substantially greater than the moving speed of sperm.

8. The method for determining sperm quality according to claim 1, further comprising collecting the sperms passing through the shrunk portion.

9. A method for separating sperms, comprising:
providing at least one first microfluidic region and at least one second microfluidic region, the first microfluidic region and the second microfluidic region meeting at a junction, an end of the second microfluidic region being provided with a collecting portion;
forming a first flow field in the first microfluidic region and a second flow field in the second microfluidic region, the first flow field and the second flow field having different directions at the junction; and
loading a semen sample at a semen sample loading end, at least one sperm moving in the first microfluidic region against the direction of the first flow field, at least one sperm moving in the second microfluidic region along the direction of the second flow field so as to be collected by the collecting portion; and
varying the velocity of the first flow field in the first microfluidic region to collect sperms with different motility.

10. The method for separating sperms according to claim 9, further comprising providing at least one third microfluidic region, wherein fluid in the third microfluidic region flows into the first microfluidic region and the second microfluidic region.

11. The method for separating sperms according to claim 10, wherein the maximum flow field velocity provided by the third microfluidic region is greater than the moving speed of sperm.

12. The method for separating sperms according to claim 9, wherein there is no sperm in the third microfluidic region substantially.

13. The method for separating sperms according to claim 9, wherein the maximum velocity of the first flow field in the first microfluidic region is substantially less than the moving speed of sperm.

14. The method for separating sperms according to claim 9, wherein the maximum velocity of the second flow field in the second microfluidic region is substantially greater than the moving speed of sperm.

15. The method for separating sperms according to claim 9, wherein the second microfluidic region comprises a shrunk portion, the width of the shrunk portion is sized to substantially allow only one sperm to pass therethrough, a detector is disposed at the shrunk portion, and the detector generates a signal upon one sperm in the semen sample passing through the shrunk portion.

16. The method for separating sperms according to claim 15, wherein the shrunk portion is an aperture or an extending channel having a length.

17. A biochip system comprising:
at least one first microfluidic region, wherein the first microfluidic region has a first flow field therein and at least one sperm moves in the first microfluidic region against the direction of the first flow field;
at least one second microfluidic region, wherein the first microfluidic region and the second microfluidic region meet at a junction, the second microfluidic region comprises a shrunk portion, the width of the shrunk portion is sized to substantially allow only one sperm to pass therethrough, the second microfluidic region has a second flow field therein, the direction of the first flow field in the first microfluidic region is different from the direction of the second flow field in the second microfluidic region at the junction, and at least one sperm moves in the second microfluidic region along the direction of the second flow field; and
a detector disposed at the shrunk portion, wherein the detector generates a signal upon one sperm passing through the shrunk portion.

18. The biochip system according to claim 17, wherein the first microfluidic region has a first end serving as a semen sample loading end.

19. The biochip system according to claim 17, wherein the first microfluidic region has a second end serving as an exit end for sperms passing through the shrunk portion.

20. The biochip system according to claim 19, further comprising a collecting portion disposed in communication with the second end.

21. The biochip system according to claim 19, further comprising an observation device disposed at the second end to observe the morphology of the sperms.

22. The biochip system according to claim 17, further comprising a third microfluidic region connected to the junction, wherein the third microfluidic region has a third end serving as a flow field source end and fluid in the third microfluidic region flows into the first microfluidic region and the second microfluidic region.

23. The biochip system according to claim 17, wherein the shrunk portion is an aperture or an extending channel having a length.
